(19) United States
(12) Patent Application Publication
(10) Pub. No.: US 2005/0285666 A1
(43) Pub. Date: Dec. 29, 2005

(54) Voltage reference generator circuit subtracting CTAT current from PTAT current

(75) Inventors: Akhil K. Garlapati, Boston, MA (US); David Pietruszynski, Austin, TX (US); Bruce P. Del Signore, Hollis, NH (US)

Correspondence Address: ZAGORIN O'BRIEN GRAHAM LLP, 7600B N. CAPITAL OF TEXAS HWY., SUITE 350, AUSTIN, TX, 78731, US

(73) Assignee: Silicon Laboratories Inc.

(21) Appl. No.: 10/877,288

(22) Filed: Jun. 25, 2004

(51) Int. Cl. H02J 1/00

(52) U.S. Cl. 327/539

(57) ABSTRACT

A voltage reference generator generates a stable reference voltage that is less than the bandgap voltage of silicon for power supply voltages less than 2V, yet provides sufficient voltage headroom to operate a current mirror. In one embodiment, the voltage reference generator has a power supply rejection ratio of at least 60 dB and has comparable noise performance as compared to traditional bandgap cirucits. These advantages are achieved by subtracting a current proportional to a complement of an absolute temperature from a current proportional to the absolute temperature to generate a voltage having a positive temperature coefficient, which is then added to a voltage that is a complement of the absolute temperature to achieve a voltage that has a low temperature coefficient.

### CROSS-REFERENCE TO RELATED APPLICATION(S)

### BACKGROUND

1. Field of the Invention

The present invention relates to generating a reference voltage in integrated circuits, and more particularly to reference voltage circuits for low-power applications.

2. Description of the Related Art

A bangap reference circuit has improved temperature stability and is less dependent on power supply voltage than other known voltage reference circuits. Bandgap reference circuits typically generate a reference voltage approximately equal to the bandgap voltage of silicon extrapolated to zero degrees Kelvin, i.e., V_{G0}=1.205V. Typical voltage reference circuits include a current mirror coupled to the power supply and the voltage reference node to provide a current proportional to the absolute temperature to the voltage reference node.

Integrated circuits having 3V power supplies can easily meet the demands of operating devices included in a cascoded current mirror and generate the reference voltage without compromising stability of the reference voltage. For example, a voltage reference generator with a power supply of 3V provides a reference voltage of 1.2V. The V_{DS} of a MOSFET included in the current mirror has a magnitude of 3V−1.2V=1.8V, which is sufficient to operate the device under typical conditions with an acceptable power supply rejection ratio (PSRR) (i.e., the ability of the voltage reference generator to reject noise on the power supply). However, as the power supply voltage drops, e.g., for low-power applications, available voltage headroom required to operate the devices included in the current mirror is reduced, the PSRR becomes more critical, and the voltage reference generator is less likely to provide a sufficiently stable reference voltage with respect to variations on the power supply.

Accordingly, improved techniques for generating stable reference voltages for low-power applications are desired.

### SUMMARY

A voltage reference generator generates a stable reference voltage that is less than the bandgap voltage of silicon for power supply voltages less than 2V, yet provides sufficient voltage headroom to operate a current mirror. In one embodiment, the voltage reference generator has a power supply rejection ratio of at least 60 dB and has a noise performance comparable to traditional bandgap circuits. These advantages are achieved by subtracting a current proportional to a complement of an absolute temperature from a current proportional to the absolute temperature to generate a voltage having a positive temperature coefficient, which is then added to a voltage that is a complement of the absolute temperature to achieve a voltage that has a low temperature coefficient.

In some embodiments of the present invention, an integrated circuit includes a first circuit and a second circuit that generate first and second currents, respectively. The first current is proportional to the absolute temperature. The second current is proportional to a complement of the absolute temperature. The integrated circuit further includes a node at which the second current is subtracted from the first current to generate a third current. The third current is proportional to an absolute temperature. The integrated circuit includes a third circuit that compensates for a temperature coefficient of the third current with a first voltage proportional to a complement of the absolute temperature. A reference voltage at the node is based at least in part on the third current and the first voltage. The temperature coefficient of the reference voltage is low.

In some embodiments of the present invention, a method for generating a reference voltage on a node of a circuit includes subtracting a current proportional to a complement of absolute temperature from a first current proportional to absolute temperature at a reference node. The subtracting generates a second current proportional to absolute temperature. The second current has a temperature coefficient more positive than the temperature coefficient of the first current. The method includes generating a first voltage proportional to absolute temperature across a resistor using the second current. The method further includes combining a second voltage proportional to a complement of absolute temperature with the first voltage to provide, at the reference node, a voltage having a low temperature coefficient.

In some embodiments of the present invention, a method of manufacturing an integrated circuit product includes forming a first circuit that generates a first current. The first current is proportional to an absolute temperature. The method includes forming a second circuit that generates a second current. The second current is proportional to a complement of the absolute temperature. The method includes forming a node at which the second current is subtracted from the first current to generate a third current. The third current is proportional to an absolute temperature. The method further includes forming a third circuit that compensates for a temperature coefficient of the third current with a first voltage proportional to a complement of the absolute temperature. A temperature coefficient of a reference voltage at the node is low. The reference voltage is based at least in part on the third current and the first voltage.

In some embodiments of the present invention, a voltage reference generator includes a resistor coupled to receive a first current. The first current is formed by subtracting a current proportional to a complement of an absolute temperature from a current proportional to the absolute temperature at a reference node, thereby generating a voltage proportional to absolute temperature across the resistor. The voltage reference generator includes a bipolar transistor coupled to the resistor and provides a voltage proportional to a complement of the absolute temperature to be combined with the voltage proportional to absolute temperature. The combination provides a reference voltage at the reference node. The reference voltage has a low temperature coefficient.

In some embodiments of the present invention, a method includes generating a first and second currents proportional to absolute temperature. The first current has a first temperature coefficient and the second current has a second temperature coefficient. The second temperature coefficient is greater than the first temperature coefficient. The method includes generating a reference voltage based on the first and second currents.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a voltage reference generator circuit.

FIG. 2 illustrates a voltage reference generator circuit in accordance with some embodiments of the present invention.

The use of the same reference symbols in different drawings indicates similar or identical items.

### DESCRIPTION OF THE PREFERRED EMBODIMENT(S)

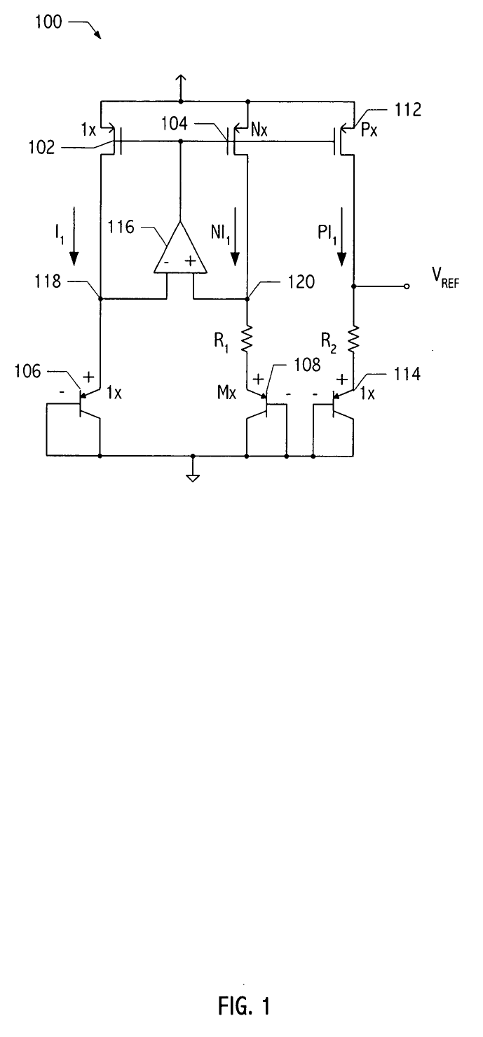

A typical voltage reference circuit (e.g., voltage reference generator 100 of FIG. 1) is designed to provide a temperature stable reference voltage (i.e., V_{REF}). In general, voltage reference circuits take advantage of two electrical characteristics to achieve the desired V_{REF}: the V_{BE} of a bipolar transistor is nearly complementary to absolute temperature, e.g., V_{BE}=(−1.5 mV/° K*T+1.22)V, and V_{T} is proportional to absolute temperature, i.e, V_{T}=kT/q.

A voltage proportional to absolute temperature (i.e., a ‘ptat’ voltage) may be obtained by taking the difference between two V_{BES} biased at different current densities:

$$Δ {V}_{BE} = {V}_{T} ln ( \frac{{J}_{1}}{{J}_{2}} ) ,$$

where J₁ and J₂ are saturation currents of corresponding bipolar transistors. Accordingly, voltage reference circuit 100 includes a pair of pnp bipolar transistors (i.e., transistors 106 and 108) that are connected in a diode configuration (i.e., the collectors and bases of these transistors are coupled together) and coupled to ground. Transistor 108 has an emitter area that is M times larger than the area of transistor 106. Thus, the saturation currents of transistor 108 and transistor 106 vary by a factor of M. The emitter of transistor 106 is coupled to an inverting input of operational amplifier 116. The emitter of transistor 108 is coupled, via resistor R₁, to the non-inverting input of operational amplifier 116. Operational amplifier 116 maintains equivalent voltages at nodes 118 and 120, i.e., V₁₁₈=V₁₂₀=V_{BE106}. Hence, the difference between V_{BE106} and V_{BE108} (i.e., ΔV_{BE106,108}) forms across resistor R₁. Operational amplifier 116 and transistors 102 and 104 convert this voltage difference into a current (i.e., current I₁) proportional to the voltage difference:

$${I}_{1} = \frac{Δ {V}_{BE106 , 108}}{{NR}_{1}} = \frac{{V}_{T} ln ( \frac{M}{N} )}{{NR}_{1}}$$

Since the thermal voltage V_{T} has a positive temperature coefficient of k/q, k=1.38*10⁻²³J/K and q=1.6*10⁻¹⁹C, the current proportional to the voltage difference is proportional to an absolute temperature, i.e., I₁ is a ‘ptat’ current.

Transistor 114 provides a voltage nearly complementary to absolute temperature (i.e., a ‘ctat’ voltage) because the V_{BE} of a bipolar transistor is nearly complementary to absolute temperature. By compensating the ptat current with a ctat voltage, transistors 102, 104, 106, 108, 112, and 114, and resistors R₁ and R₂, may be appropriately sized to generate a particular reference voltage output having a zero temperature coefficient:

$$\frac{{V}_{REF} - {V}_{BE114}}{{R}_{2}} = {PI}_{1} ;$$

$${V}_{REF} = {V}_{BE114} + {PI}_{1} {R}_{2} ;$$

$${V}_{REF} = {V}_{BE114} + \frac{{PR}_{2} {V}_{T} ln ( \frac{M}{N} )}{{NR}_{1}} ;$$

$$\frac{ⅆ {V}_{REF}}{ⅆ T} = \frac{ⅆ {V}_{BE114}}{ⅆ T} + \frac{{PR}_{2} k ln ( \frac{M}{N} )}{{NR}_{1} q} .$$

Setting

$$\frac{ⅆ {V}_{REF}}{ⅆ T} = 0 ,$$

for V_{REF} to have a zero temperature coefficient,

$$\frac{{PR}_{2} k ln ( \frac{M}{N} )}{{NR}_{1} q} = - \frac{ⅆ {V}_{BE114}}{ⅆ T} = \frac{1.5 mV}{° K} .$$

V_{BE114}=V_{BE106}=0.74 at 300° K for an exemplary process and choosing M=8, N=¼, P/N˜4, and R₂/R₁˜1.2:

$${V}_{REF} = {V}_{BE114} + \frac{{PR}_{2} {V}_{T} ln ( \frac{M}{N} )}{{NR}_{1}} ;$$

$${V}_{REF} = 0.74 V + \frac{1.5 mV}{° K} T ;$$

at 300° K, V_{REF}=0.74V+0.45V=1.19V≈1.2V.
V_{REF} is approximately equal to, V_{G0}=1.205V, i.e., the bandgap voltage of silicon extrapolated to zero degrees Kelvin.

When the power supply is 3V, the V_{DS} of transistor 112 has a magnitude of 3V−1.2V=1.8V, which is sufficient to operate the device to provide a current independent of fluctuations in V_{DS}. Thus power supply noise will have a minimal effect on I₁. However, for an exemplary low-power application, the power supply voltage is 1.62V. Voltage reference generator 100 provides only a V_{DS} of 0.42V for device 112. Transistor 112 may be operating in a linear/quasi-saturation current region and noise on the power supply will cause significant noise in PI₁, thereby generating a noisy V_{REF} and degrading the accuracy of V_{REF}. The PSRR is typically determined empirically by presenting a varying signal on the power supply and measuring variations exhibited at the V_{REF} node. At a 1.62V power supply, voltage reference generator 100 is unable to provide a desired 60 dB PSRR. The poor power supply rejection of voltage reference generator 100 makes voltage reference generator 100 inoperable for the purpose of providing a stable voltage reference. A desired voltage reference generator PSRR for a low-power application is at least 60 dB over process and temperature variations. In addition, noise from operational amplifier 116, which dominates the circuit noise of voltage reference generator 100, is amplified by a factor of \sqrt{P} by the current mirror thus amplifying noise on V_{REF}.

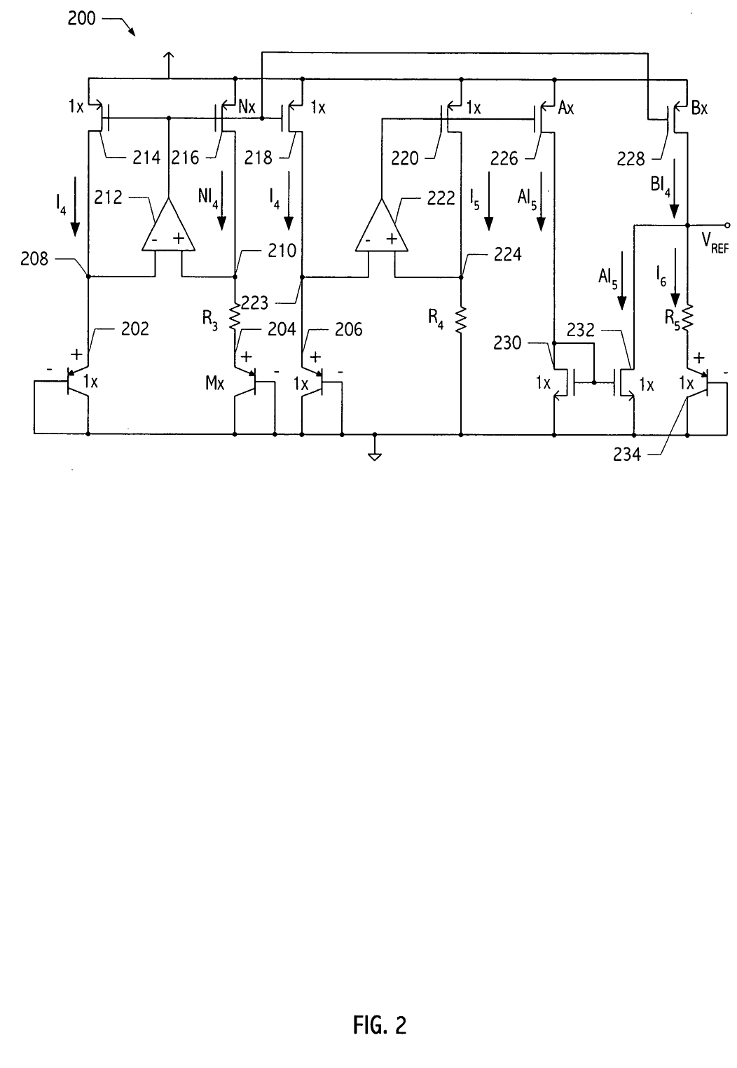

Referring to FIG. 2, voltage reference generator 200 improves the power supply rejection ratio as compared to voltage reference generator 100, without increasing the noise performance, by subtracting a current complementary to absolute temperature from a current proportional to absolute temperature and by maintaining V_{DS} of corresponding current mirror transistors to operate the current mirror transistors in a saturation region. Voltage reference circuit 200 includes a pair of pnp bipolar transistors (i.e., transistors 202 and 204) that are coupled in a diode configuration and coupled to ground. Transistor 204 has an emitter area that is M times larger than the area of transistor 202. Thus, transistor 204 has a current density that varies from the current density of transistor 202 by a factor of M. The emitter of transistor 202 is coupled to an inverting input of operational amplifier 212. The emitter of transistor 204 is coupled, via resistor R₃, to the non-inverting input of operational amplifier 212. Operational amplifier 212 maintains equivalent voltages at nodes 208 and 210, i.e., V₂₀₈=V₂₁₀=V_{BE202}. Hence, the difference between V_{BE202} and V_{BE204} (i.e., ΔV_{BE202,204}) forms across resistor R₃. Operational amplifier 212 and transistors 214 and 216 convert this voltage difference into a current (i.e., current I₄) proportional to the voltage difference:

$${I}_{4} = \frac{Δ {V}_{BE202 , 204}}{{NR}_{3}} = \frac{{V}_{T} ln ( \frac{M}{N} )}{{NR}_{3}}$$

Since the thermal voltage V_{T} has a positive temperature coefficient of k/q, k=1.38*10⁻²³J/K and q=1.6*10⁻¹⁹C, I₄, is a ptat current. Transistor 228 provides node V_{REF} with a mirrored I₄ current, amplified by B.

Transistor 206 provides a ctat voltage because the V_{BE} of a pnp bipolar transistor is nearly complementary to absolute temperature. The emitter of transistor 206 is coupled to an inverting input of operational amplifier 222. The resistor R₄ is coupled to the non-inverting input of operational amplifier 222. Operational amplifier 222 maintains equivalent voltages at nodes 223 and 224, i.e., V₂₂₃=V₂₂₄=V_{BE206}. Hence, a ctat current proportional to V_{BE206} flows through resistor R₄:

$${I}_{5} = \frac{{V}_{BE206}}{{R}_{4}} .$$

Transistors 226, 230, and 232 form mirror current I₅ with a gain of A, thus, providing a ctat current AI₅ that is subtracted from BI₄ at node V_{REF}.

Transistor 234 provides a ctat voltage because the V_{BE} of bipolar transistor is nearly complementary to absolute temperature. By subtracting a ctat current from a ptat current and compensating for a remaining ptat current with a ctat voltage, transistors 214, 216, 202, 204, 218, 206, 220, 226, 228, 230, and 234, and resistors R₃, R₄, and R₅, may be appropriately sized to generate a particular reference voltage output, V_{REF}, having a low (e.g., substantially zero) temperature coefficient (e.g., less than 1 μV/° K over a given temperature range):

$${BI}_{4} = \frac{{V}_{REF} - {V}_{BE234}}{{R}_{5}} + \frac{{AV}_{BE206}}{{R}_{4}} ;$$

$${V}_{REF} = {BI}_{4} {R}_{5} + {V}_{BE234} - \frac{{AR}_{5} {V}_{BE206}}{{R}_{4}} ;$$

$${I}_{4} = \frac{{V}_{T} ln ( \frac{M}{N} )}{{NR}_{3}} .$$

Choosing M=8 and N=1/4,

$${I}_{4} = \frac{4 {V}_{T} ln ( 32 )}{{R}_{3}} . \\ at 300 ° K , {V}_{234} \approx {V}_{206} \approx 0.74 V ;$$

$$\frac{ⅆ {V}_{BE3}}{ⅆ T} \approx \frac{ⅆ {V}_{BE4}}{ⅆ T} \approx - 1.5 \frac{mV}{° K} .$$

Choosing A=1/4, B=3/2;

$${V}_{REF} = 6 {V}_{T} \frac{{R}_{5}}{{R}_{3}} ln ( 32 ) - ( \frac{1}{4} ) \frac{{R}_{5}}{{R}_{4}} {V}_{BE206} + {V}_{BE234} .$$

Setting

$$\frac{ⅆ {V}_{REF}}{ⅆ T} = 0 ,$$

for V_{REF} to have a zero temperature coefficient,

$$\frac{ⅆ {V}_{REF}}{ⅆ T} = 6 \frac{k}{q} \frac{{R}_{5}}{{R}_{3}} ln ( 32 ) + ( \frac{1}{4} ) \frac{{R}_{5}}{{R}_{4}} 1.5 * {10}^{- 3} - 1.5 * {10}^{- 3} ;$$

$$4.8 \frac{{R}_{5}}{{R}_{3}} + \frac{{R}_{5}}{{R}_{4}} = 4.$$

For currents AI₅ and I₆ to be positive,

$${BI}_{4} > A \frac{{V}_{BE206}}{{R}_{4}} ;$$

$$6 {V}_{T} ln 32 \frac{{R}_{5}}{{R}_{3}} > ( \frac{1}{4} ) {V}_{BE206} \frac{{R}_{5}}{{R}_{4}} ;$$

$$\frac{{R}_{4}}{{R}_{3}} > \frac{1.22 - 1.5 * {10}^{- 3} T}{7.17 * {10}^{- 3} T} .$$

Evaluating over a temperature range (e.g., −55° C.<T<125° C.), at −55° C. (i.e., T=218° K),

$$\frac{{R}_{4}}{{R}_{3}} > 0.5713 , and$$

$$at 125 ° C . ( i . e . , T = 398 ° K ) , \\ \frac{{R}_{4}}{{R}_{3}} > 0.2183 . \\ Therefore , \frac{{R}_{4}}{{R}_{3}} > 0.5713 .$$

Also,

$$\frac{{R}_{5}}{{R}_{4}} = 4 - 4.8 \frac{{R}_{5}}{{R}_{3}} > 0$$

for the ratio of the two resistors to be positive;

$$\frac{{R}_{5}}{{R}_{3}} < \frac{4}{4.8} = 0.833 . \\ {V}_{REF} = 6 {V}_{T} \frac{{R}_{5}}{{R}_{3}} ln ( 32 ) - ( \frac{1}{4} ) \frac{{R}_{5}}{{R}_{4}} {V}_{BE206} + {V}_{BE234} .$$

Assuming V_{BE206}=V_{BE234}=V_{BE},

$${V}_{REF} = 6 {V}_{T} \frac{{R}_{5}}{{R}_{3}} ln 32 + ( 1 - ( \frac{1}{4} ) \frac{{R}_{5}}{{R}_{4}} ) {V}_{BE}$$

$${V}_{REF} = 6 {V}_{T} \frac{{R}_{5}}{{R}_{3}} ln 32 + ( 1 - ( \frac{1}{4} ) \frac{{R}_{5}}{{R}_{4}} ) ( 1.22 - 1.5 * {10}^{- 3} T )$$

Substituting

$$\frac{{R}_{5}}{{R}_{4}} = 4 - 4.8 \frac{{R}_{5}}{{R}_{3}} ,$$

$${V}_{REF} = 6 {V}_{T} \frac{{R}_{5}}{{R}_{3}} ln 32 + ( 1 - 1 + 1.2 \frac{{R}_{5}}{{R}_{3}} ) ( 1.22 - 1.5 * {10}^{- 3} T ) ;$$

$${V}_{REF} = 1.8 * {10}^{- 3} \frac{{R}_{5}}{{R}_{3}} T + ( 1.464 \frac{{R}_{5}}{{R}_{3}} ) - 1.8 * {10}^{- 3} \frac{{R}_{5}}{{R}_{3}} T ;$$

$${V}_{REF} = 1.464 \frac{{R}_{5}}{{R}_{3}} . \\ Since \frac{{R}_{5}}{{R}_{3}} < \frac{4}{4.8} = 0.833 , \\ {V}_{REF} < 1.22 V . \\ However , \frac{{R}_{4}}{{R}_{3}} > 0.5713 and$$

$$\frac{{R}_{5}}{{R}_{4}} < \frac{{R}_{5}}{0.5713 {R}_{3}} ;$$

$$\frac{{R}_{5}}{{R}_{4}} + 4.8 \frac{{R}_{5}}{{R}_{3}} < \frac{{R}_{5}}{0.5713 {R}_{3}} + 4.8 \frac{{R}_{5}}{{R}_{3}} .$$

From above,

$$\frac{{R}_{5}}{{R}_{4}} + 4.8 \frac{{R}_{5}}{{R}_{3}} = 4 ;$$

$$\frac{{R}_{5}}{0.5713 {R}_{3}} + 4.8 \frac{{R}_{5}}{{R}_{3}} > 4 ;$$

$$\frac{{R}_{5}}{{R}_{3}} > 0.61 .$$

V_{REF}>(1.464)0.61=0.893V.
Hence, 0.893V<V_{REF}<1.22V.
Choosing V_{REF}=0.96V, in one embodiment of the present invention, R₃=7.5 kΩ, R₄=5.28 kΩ, R₅=4.82 kΩ. The values given above are exemplary. Other values (e.g., resistances and transistor sizes) may be selected to obtain an appropriate voltage reference in a given environment.

Voltage reference generator 200 provides reference voltages less than 1.0V (e.g., 0.96V) by subtracting a ctat current AI₅ from ptat current BI₄ to generate a current proportional to absolute temperature having a temperature coefficient more positive than the temperature coefficient of BI₄. A current having a temperature coefficient greater than the temperature coefficient of BI₄ may also be achieved by adding a ptat current to B I₄ to form I₆. As described above, the reference voltage of voltage reference generator 100 is

$${V}_{REF} = {V}_{BE114} + \frac{{PR}_{2} {V}_{T} ln ( \frac{M}{N} )}{{NR}_{1}} ,$$

which may be modeled as
V_{REF}=V_{BE}+C₁R₂T.
The reference voltage of voltage reference generator 200 is

$${V}_{REF} = {V}_{BE234} + {R}_{5} ( {BI}_{4} - {AI}_{5} ) \\ {V}_{REF} = {V}_{BE234} + {R}_{5} ( \frac{{BV}_{T} ln ( \frac{M}{N} )}{{NR}_{3}} - \frac{{AV}_{BE206}}{{R}_{4}} ) \\ {V}_{REF} = {V}_{BE234} + {R}_{5} ( \frac{{B4V}_{T} ln 32}{{R}_{3}} ) + {R}_{5} \frac{A ( 1.5 mV / {}^{°} KT )}{{R}_{4}} - {R}_{5} \frac{1.22 V}{{R}_{4}} ) ,$$

which may be modeled as
V_{REF}=V_{BE}+C₂R₅T+C₃R₅.
Since C₂ (i.e., the slope of current I₆ with respect to temperature) is greater than C₁ (i.e., the slope of current I₁ with respect to temperature), to maintain a constant voltage with respect to temperature, resistor R₅ is smaller than R₂. However, C₃, i.e., the offset of ptat current I₆, is negative, thus reducing the reference voltage produced by voltage reference generator 200 from that produced by voltage reference generator 100 (e.g., below 1.2V). The increase in the temperature coefficient of I₆ and the offset of current I₆ allows reducing V_{REF} below 1.2V while maintaining a substantially zero temperature coefficient of V_{REF}. The increase in the temperature coefficient of I₆ also allows reducing B, which reduces noise contributions from operational amplifier 212 at V_{REF}. A smaller B also results in transistor 228 operating farther from its linear/quasi-saturation region.

The reduction in V_{REF} from 1.2V improves the PSRR because the voltage headroom for the current mirror is at least 1.62V−0.96V=0.66V. Noise performance of voltage reference generator 200 is similar to that for voltage reference generator 100 because the noise from operational amplifier 222 is attenuated by A, thus the dominant noise component is from operational amplifier 212. Ptat current I₆ has a greater slope as a function of temperature than ptat current BI₄. The exemplary embodiment of circuit 200 was designed for a supply voltage of 1.62V and a reference voltage of 0.96V, however, this circuit is not limited thereto. Voltage reference generator 200 may be operated at other supply voltages and reference voltages, and remains operable so long as V_{DD}−V_{REF}>400 mV (i.e., the current mirror remains operable) and 1.22V>V_{REF}>0.893V.

While circuits and physical structures are generally presumed, it is well recognized that in modern semiconductor design and fabrication, physical structures and circuits may be embodied in computer readable descriptive form suitable for use in subsequent design, test, or fabrication stages. Structures and functionality presented as discrete components in the exemplary configurations may be implemented as a combined structure or component. The invention is contemplated to include circuits, systems of circuits, related methods, and computer-readable medium encodings of such circuits, systems, and methods, all as described herein, and as defined in the appended claims. As used herein, a computer readable medium includes at least disk, tape, or other magnetic, optical, semiconductor (e.g., flash memory cards, ROM), or electronic medium and a network, wireline, wireless or other communications medium.

1. An integrated circuit comprising:
a first circuit, the first circuit generating a first current, the first current proportional to an absolute temperature;
a second circuit, the second circuit generating a second current, the second current proportional to a complement of the absolute temperature; and
a node at which the second current is subtracted from the first current to generate a third current, the third current proportional to an absolute temperature; and
a third circuit, the third circuit compensating for a temperature coefficient of the third current with a first voltage proportional to a complement of the absolute temperature; and
wherein a temperature coefficient of a reference voltage at the node is low, the reference voltage based at least in part on the third current and the first voltage.

2. The integrated circuit, as recited in claim 1, wherein a temperature coefficient of the third current is more positive than a temperature coefficient of the first current.

3. The integrated circuit, as recited in claim 1, wherein the third current includes an offset component independent of temperature.

4. The integrated circuit, as recited in claim 1, wherein the first circuit comprises two bipolar transistors operating at different current densities.

5. The integrated circuit, as recited in claim 1, wherein the second circuit comprises a bipolar transistor providing a voltage with a negative temperature coefficient.

6. The integrated circuit, as recited in claim 1, wherein the third circuit comprises a bipolar transistor providing a voltage with a negative temperature coefficient.

7. The integrated circuit, as recited in claim 1, wherein the subtracting reduces the reference voltage on the node below a bandgap voltage.

8. The integrated circuit, as recited in claim 1, wherein the low temperature coefficient of the reference voltage is approximately zero.

9. The integrated circuit, as recited in claim 1, wherein the reference voltage satisfies the relationship 0.893<V<1.22.

10. The integrated circuit, as recited in claim 9, wherein the reference voltage is less than 1.0V.

11. The integrated circuit, as recited in claim 9, wherein the reference voltage is measured with reference to ground.

12. The integrated circuit, as recited in claim 1, wherein the power supply rejection ratio is at least 60 dB.

13. The integrated circuit, as recited in claim 1, wherein the first circuit comprises a first operational amplifier maintaining effective equivalence of voltages on a first node and a second node of the first circuit and the second circuit comprises a second operational amplifier maintaining effective equivalence of voltages on a first node and a second node of the second circuit.

14. The integrated circuit, as recited in claim 1, wherein the first circuit comprises a first current mirror coupled to the voltage reference node, the first current mirror amplifying a current proportional to absolute temperature to supply the first current.

15. The integrated circuit, as recited in claim 14, wherein the second circuit comprises a second current mirror coupled to the voltage reference node, the second current mirror attenuating a current proportional to a complement of absolute temperature to supply the second current.

16. The integrated circuit, as recited in claim 15, wherein the second current mirror attenuates noise contributed by an operational amplifier maintaining effective equivalence of voltages on a first node and a second node of the second circuit.

17. The integrated circuit, as recited in claim 1, wherein noise on the voltage reference node is predominately noise from an operational amplifier maintaining effective equivalence of voltages on a first node and a second node of the first circuit.

18. A method for generating a reference voltage on a node of a circuit comprising:
subtracting a current proportional to a complement of absolute temperature from a first current proportional to absolute temperature at a reference node to generate a second current proportional to absolute temperature having a temperature coefficient more positive than the temperature coefficient of the first current;
generating a first voltage proportional to absolute temperature across a resistor using the second current; and
combining a second voltage proportional to a complement of absolute temperature with the first voltage to provide at the reference node a voltage having a low temperature coefficient.

19. The method, as recited in claim 18, further comprising:
operating two bipolar transistors at different current densities to generate the first current.

20. The method, as recited in claim 18, further comprising:
maintaining substantial equivalence of a voltage on a first node and a voltage on a second node with a first operational amplifier, the first and second nodes used to generate the first current.

21. The method, as recited in claim 20, further comprising:
maintaining substantial equivalence of a voltage on a third node and a voltage on a fourth node with a second operational amplifier, the third and fourth nodes used to generate the current proportional to a complement of absolute temperature.

22. The method, as recited in claim 21, further comprising:
attenuating noise from the second operational amplifier affecting the voltage reference node by attenuating a mirrored current.

23. The method, as recited in claim 18, wherein the subtracting reduces the voltage to be less than a bandgap voltage.

24. The method, as recited in claim 20, wherein noise on the voltage reference node is predominately noise from the first operational amplifier.

25. A computer readable medium encoding a description of an integrated circuit product comprising:
a first circuit, the first circuit generating a first current, the first current proportional to an absolute temperature;
a second circuit, the second circuit generating a second current, the second current proportional to a complement of the absolute temperature; and
a node at which the second current is subtracted from the first current to generate a third current, the third current proportional to an absolute temperature; and
a third circuit, the third circuit compensating for a temperature coefficient of the third current with a first voltage proportional to a complement of the absolute temperature; and
wherein a temperature coefficient of a reference voltage at a voltage reference node is low, the reference voltage based at least in part on the third current and the first voltage.

26. A method of manufacturing an integrated circuit product, the method comprising:
forming a first circuit, the first circuit generating a first current, the first current proportional to an absolute temperature;
forming a second circuit, the second circuit generating a second current, the second current proportional to a complement of the absolute temperature; and
forming a node at which the second current is subtracted from the first current to generate a third current, the third current proportional to an absolute temperature; and
forming a third circuit, the third circuit compensating for a temperature coefficient of the third current with a first voltage proportional to a complement of the absolute temperature; and
wherein a temperature coefficient of a reference voltage at the node is low, the reference voltage based at least in part on the third current and the first voltage.

27. The method, as recited in claim 26, wherein a temperature coefficient of the third current is more positive than a temperature coefficient of the first current.

28. The method, as recited in claim 26, wherein the third current includes an offset component independent of temperature.

29. The method, as recited in claim 26, wherein the first circuit comprises two bipolar transistors operating at different current densities.

30. The method, as recited in claim 26, wherein the second circuit comprises a bipolar transistor providing a voltage with a negative temperature coefficient.

31. The method, as recited in claim 26, wherein the third circuit comprises a bipolar transistor providing a voltage with a negative temperature coefficient.

32. The method, as recited in claim 26, wherein the subtracting reduces the reference voltage at the voltage reference node to be less than a bandgap voltage.

33. The method, as recited in claim 26, wherein the first circuit comprises a first current mirror coupled to the voltage reference node, the first current mirror amplifying the first current.

34. The method, as recited in claim 33, wherein the second circuit comprises a second current mirror coupled to the voltage reference node, the second current mirror attenuating the second current.

35. A voltage reference generator comprising:
a resistor coupled to receive a first current, the first current being formed by subtracting a current proportional to a complement of an absolute temperature from a current proportional to an absolute temperature at a reference node, thereby generating a voltage proportional to absolute temperature across the resistor; and
a bipolar transistor coupled to the resistor and providing a voltage proportional to a complement of the absolute temperature that combined with the voltage proportional to absolute temperature provides a reference voltage at the reference node having a low temperature coefficient.

36. The voltage reference generator, as recited in claim 35, wherein a temperature coefficient of the first current is more positive than a temperature coefficient of the current proportional to absolute temperature.

37. The voltage reference generator, as recited in claim 35, wherein the first current includes an offset component independent of temperature.

38. The voltage reference generator, as recited in claim 35, wherein the reference voltage is below a bandgap voltage.

39. The voltage reference generator, as recited in claim 38, wherein the reference voltage is 1.0V.

40. An apparatus comprising:
means for generating a first current, the first current proportional to an absolute temperature;
means for generating a second current, the second current proportional to a complement of the absolute temperature; and
means for subtracting the second current from the first current to generate a third current, the third current having a temperature coefficient more positive than the temperature coefficient of the first current; and
means for compensating for a positive temperature coefficient of the third current to generate a voltage on a node having a low temperature coefficient.

41. The apparatus, as recited in claim 40, comprising:
means for attenuating noise from the means for generating the second current.

42. A method for generating a reference voltage on a node of a circuit comprising:
generating a first current proportional to absolute temperature, the first current having a first temperature coefficient;
generating a second current proportional to absolute temperature, the second current having a second temperature coefficient, the second temperature coefficient being greater than the first temperature coefficient; and
generating a reference voltage based on the first and second currents.

43. The method, as recited in claim 42, wherein the second current includes an offset component independent of temperature.

44. The method, as recited in claim 42, wherein the reference voltage is less than a bandgap voltage.
